(19) United States
(12) Patent Application Publication
(10) Pub. No.: US 2026/0050529 A1
(43) Pub. Date: Feb. 19, 2026

(54) DATA ANOMALY DETECTION, NOTIFICATION, AND MANAGEMENT

(71) Applicant: American Express Travel Related Services Company, Inc., New York, NY (US)

(72) Inventors: Swagata Ghosh, Phoenix, AZ (US); Abhishek Jee, Phoenix, AZ (US); Rajesh Ray Shrestha, Phoenix, AZ (US); Nicholas Bayne Grubb, Atlanta, GA (US)

(21) Appl. No.: 19/001,949

(22) Filed: Dec. 26, 2024

Related U.S. Application Data
(60) Provisional application No. 63/683,697, filed on Aug. 15, 2024.

(51) Int. Cl. G06F 11/32; G06F 11/34; G06T 11/20

(52) U.S. Cl. CPC G06F 11/321; G06F 11/3476; G06T 11/206

(57) ABSTRACT

An example operation may include one or more of ingesting data from a plurality of systems, dividing the data into a plurality of bins based on binning configuration settings, identifying a bin of data among the plurality of bins which contains an anomaly at a point in time based on thresholds for the plurality of bins, identifying a different bin of data among the plurality of bins which does not contain the anomaly at the point in time based on the thresholds for the plurality of bins, generating a heat map comprising a plurality of display elements corresponding to the plurality of bins including a display element corresponding to the bin of data with the anomaly with a different visual appearance than a display element corresponding to the different bin which does not contain the anomaly, and rendering the heat map via a GUI.

### CROSS-REFERENCE TO RELATED APPLICATION

This application claims priority to U.S. provisional application No. 63/683,697, entitled “DATA ANOMALY DETECTION AND MANAGEMENT PLATFORM”, filed on Aug. 15, 2024, the entire disclosure of which is incorporated by reference herein.

### BACKGROUND

In various systems, accurate data can be critical for various activities such as regulatory reporting, management decision-making, operational efficiency, and the like. However, the large volume of data that can be processed, especially on a daily basis, can contain inconsistencies or anomalies that, if undetected, may lead to incorrect reporting or operational failures. Existing systems for anomaly detection are inadequate, as they either fail to detect subtle anomalies in real-time or generate excessive false positives, overwhelming support teams and systems, and delaying resolution.

### SUMMARY

One example embodiment provides an apparatus that may include a memory and at least one processor communicatively coupled to the memory, where the at least one processor is configured to one or more of ingest data from a plurality of systems through a software application, divide the data into a plurality of bins based on binning configuration settings that are defined within the software application, identify a bin of data among the plurality of bins which contains an anomaly at a point in time based on thresholds for the plurality of bins, identify a different bin of data among the plurality of bins which does not contain the anomaly at the point in time based on the thresholds for the plurality of bins, generate a heat map comprising a plurality of display elements corresponding to the plurality of bins including a display element corresponding to the bin of data with the anomaly with a different visual appearance than a display element corresponding to the different bin which does not contain the anomaly, and render the heat map via a graphical user interface (GUI) of the software application.

Another example embodiment provides a method that includes one or more of ingesting data from a plurality of systems through a software application, dividing the data into a plurality of bins based on binning configuration settings that are defined within the software application, identifying a bin of data among the plurality of bins which contains an anomaly at a point in time based on thresholds for the plurality of bins, identifying a different bin of data among the plurality of bins which does not contain the anomaly at the point in time based on the thresholds for the plurality of bins, generating a heat map comprising a plurality of display elements corresponding to the plurality of bins including a display element corresponding to the bin of data with the anomaly with a different visual appearance than a display element corresponding to the different bin which does not contain the anomaly, and rendering the heat map via a graphical user interface (GUI) of the software application.

A further example embodiment provides a computer program product comprising: one or more computer-readable storage media, and program instructions stored on the one or more computer-readable storage media to perform operations comprising one or more of ingesting data from a plurality of systems through a software application, dividing the data into a plurality of bins based on binning configuration settings that are defined within the software application, identifying a bin of data among the plurality of bins which contains an anomaly at a point in time based on thresholds for the plurality of bins, identifying a different bin of data among the plurality of bins which does not contain the anomaly at the point in time based on the thresholds for the plurality of bins, generating a heat map comprising a plurality of display elements corresponding to the plurality of bins including a display element corresponding to the bin of data with the anomaly with a different visual appearance than a display element corresponding to the different bin which does not contain the anomaly, and rendering the heat map via a graphical user interface (GUI) of the software application.

### BRIEF DESCRIPTION OF THE DRAWINGS

FIG. 1A is a diagram illustrating a computing environment for transferring data between different systems according to an embodiment of the instant solution.

FIG. 1B is a diagram illustrating a process of detecting an anomaly in the data and displaying information about the anomaly according to an embodiment of the instant solution.

FIG. 1C is another diagram illustrating a process of detecting an anomaly in the data and displaying information about the anomaly according to an embodiment of the instant solution.

FIG. 1D is a further diagram illustrating a process of detecting an anomaly in the data and displaying information about the anomaly according to an embodiment of the instant solution.

FIG. 2A is a diagram illustrating a process of generating a heat map of anomaly within bins of data according to an embodiment of the instant solution.

FIG. 2B is a diagram illustrating a process of configuring the anomaly detection according to an embodiment of the instant solution.

FIG. 3 is a diagram illustrating a process of dynamically generating thresholds for anomaly detection according to an embodiment of the instant solution.

FIG. 4A is a diagram illustrating a process of determining a cause of an anomaly within the data according to an embodiment of the instant solution.

FIG. 4B is a diagram illustrating a process of determining and testing a solution for the anomaly according to an embodiment of the instant solution.

FIG. 4C is a diagram illustrating a process of modifying the heat map when an anomaly is solved according to an embodiment of the instant solution.

FIG. 5A is a system diagram illustrating integration of an AI model into any decision point according to an embodiment of the instant solution.

FIG. 5B is a diagram illustrating a process for developing an AI model that supports AI-assisted computer decision points according to an embodiment of the instant solution.

FIG. 5C is a diagram illustrating a process for utilizing an AI model that supports AI-assisted computer decision points according to an embodiment of the instant solution.

FIG. 6A is a flow diagram illustrating a method according to an embodiment of the instant solution.

FIG. 6B is a flow diagram illustrating a method according to an embodiment of the instant solution.

FIG. 7 is a diagram illustrating a computing system for use with the examples described herein according to an embodiment of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a system that can detect the presence of an anomaly within data (in real-time) and can provide a warning of the anomaly within the data through a heat map displayed on a graphical user interface. The data may include electronic messages, payment transactions, database transactions, API calls, and the like, which can be generated by computing systems within a network. The anomaly may refer to errors or other issues that are present within the data which cause the data to fail to adhere to at least one of a format, a type, a protocol, a policy, a rule, and/or the like.

In larger systems where many pieces of data (e.g., thousands, millions, etc.) are transferred in a short amount of time, the failure to detect such anomalies in real-time (and/or in near real-time) can lead to significant problems that can ultimately cause downtime for the systems as they may need to be taken offline until the problem is fixed. Another problem with such anomalies is that identifying the problem (and ultimately the solution) can take significant time and effort because it can be difficult to efficiently sift through a large amount of data.

In the example embodiments, the data can be binned together into smaller collections of data (referred to herein as bins) which creates a practical application (technical benefit) because once binned, the data can be evaluated by bins. The evaluation process may be performed simultaneously (e.g., all bins at the same time, etc.) which can speed up the processing of the anomaly detection. This can significantly reduce the amount of time it takes to identify the anomaly and determine a solution for the anomaly. In addition, the system described herein may also provide an artificial intelligence (AI) model or models, which can predict the reason (cause) for the anomaly, a possible solution for the anomaly, and even test the solution to ensure that the anomaly is corrected. Furthermore, the system can change the heat map on the GUI to reflect that the anomaly has been resolved (e.g., changing a red alert to a green alert, etc.).

As an example, anomaly detection may be performed to detect outliers or inconsistencies in the data. For example, the system may determine standard deviations of the data using a rolling window of the data values, and perform cluster analysis and time series forecasting analysis on time series data to determine whether a new data value is an outlier or not. This may involve multiple decisions being generated by an instant software application. For example, a first decision may include determining whether the new data value is greater than three standard deviations. A second decision may include analyzing whether a new data value belongs to a seasonal cluster or not. A third decision may include determining an expected value using the time series forecasting analysis on time-series data for the bin, and determining if the expected value is greater than a threshold. In this example, the system may report an anomaly if the first decision is true and the second decision is false. The system may further report an anomaly if the first decision is true and the third decision is false. Furthermore, the system may provide a capability to tag data points as true anomalies, and such data points may then be removed from the future training process.

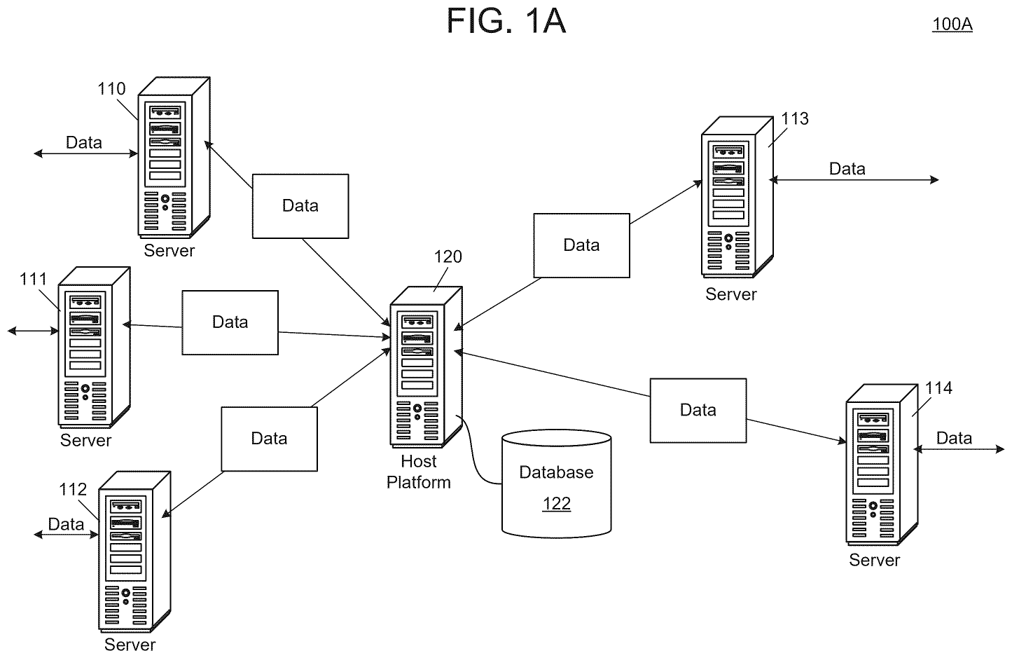

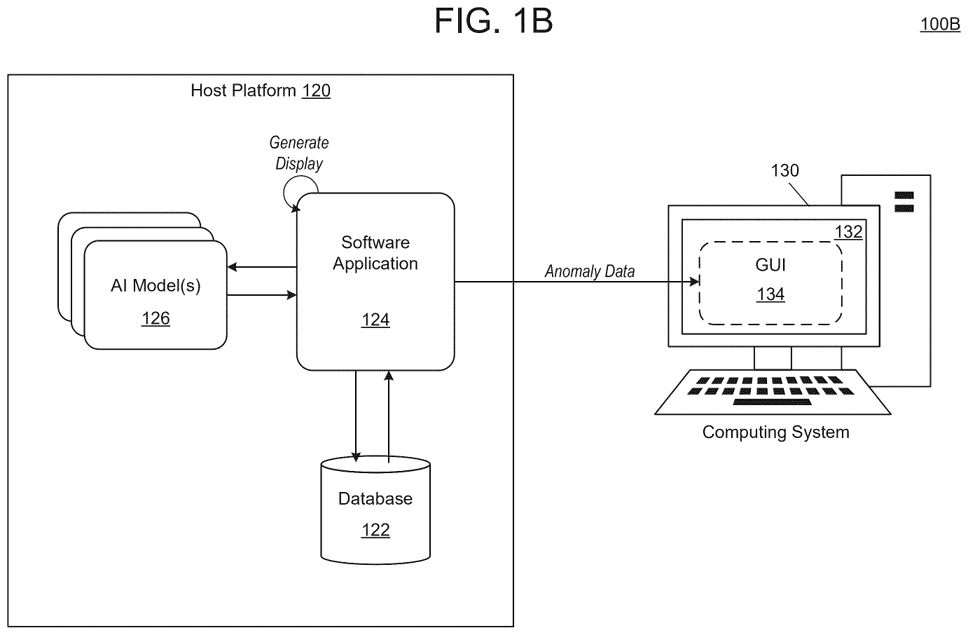

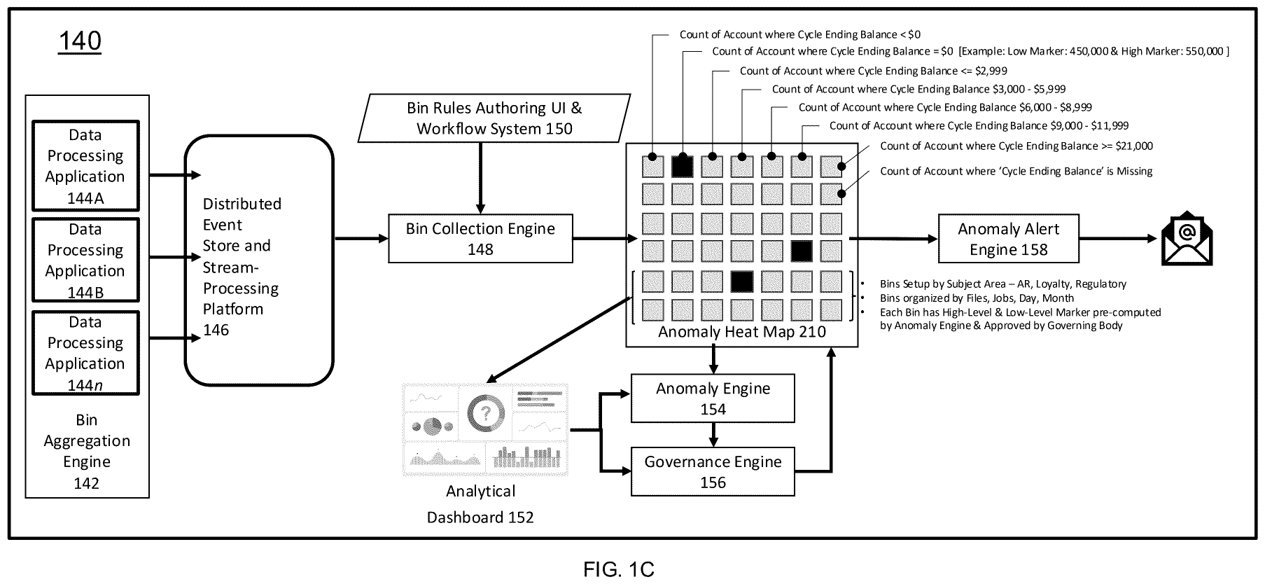

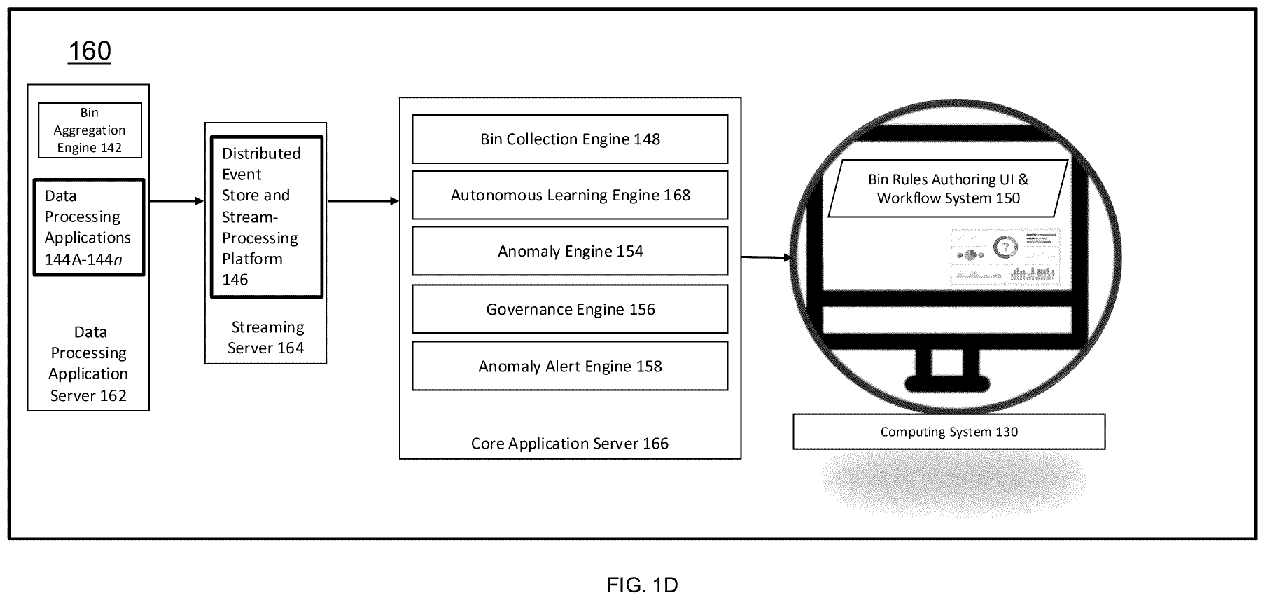

FIG. 1A illustrates a computing environment 100A for transferring data between different systems according to an embodiment of the instant solution. Referring to FIG. 1A, the computing environment 100A includes a plurality of computing systems in a network environment. As an example, the plurality of computing systems may correspond to different servers (or the like) which are part of a shared entity such as a payment network, a cloud platform, a blockchain platform, a distributed database, content delivery systems, and the like.

According to various embodiments, the plurality of computing systems may transfer data between each other (e.g., electronic messages, transactions, payment transactions, database transactions, API calls, content, database tables, etc.) In some cases, the data may contain anomalies (e.g., a value in a wrong field, a missing value, an incorrect format, etc.) Over time, these anomalies can result in significant issues within the system because functions such as data storage, system operation, communications, and the like, may be disrupted by the anomalies.

In the example of FIG. 1A, a host platform 120 (which can be part of the plurality of computing systems) may include a software application installed therein which may be used to detect for and manage the occurrence of anomalies. The host platform 120 may include a web server, a cloud platform, a local server, and the like. The host platform 120 may receive the data from different systems, for example, a server 110, a server 111, a server 112, a server 113, a server 114, and the like. The host platform 120 may also transmit data to the different systems. The host platform 120 may store the data it receives, transmits, etc., within a database 122. For example, the host platform 120 may transmit/receive messages, transactions, calls, content, tables, etc. and store the data within database tables, documents, or the like, in the database 122. Furthermore, the software application installed on the host platform 120 may analyze the data for anomalies.

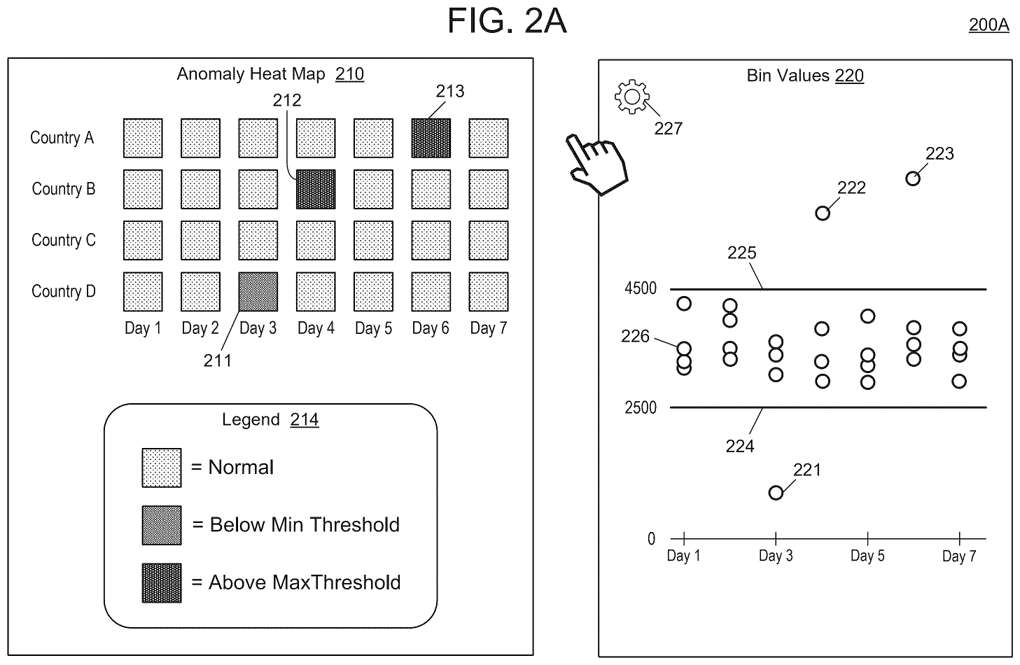

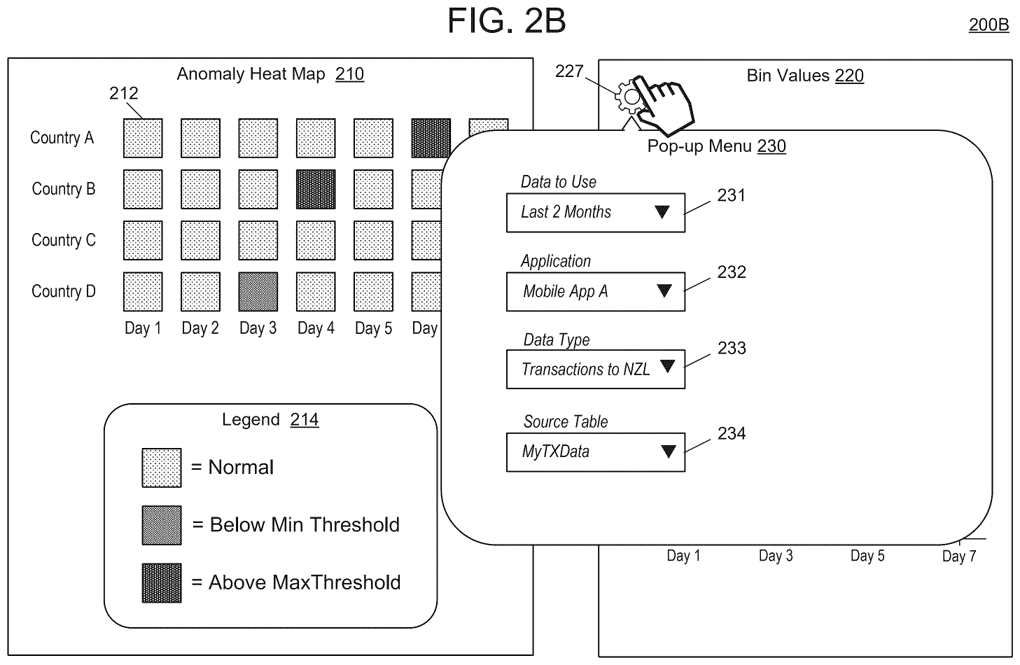

FIG. 1B illustrates a process 100B of detecting an anomaly in the data and displaying information about the anomaly according to an embodiment of the instant solution. Referring to FIG. 1B, the host platform 120 may host a software application 124 capable of dividing granular amounts of data into smaller groups referred to as “bins”. The software application 124 may then analyze each of the bins for anomalies. The software application 124 may also generate a graphical user interface (GUI) 134 with a heat map (e.g., shown in the example of FIG. 2A), which includes identifiers of the bins, and colors/shading that identify which bins contain anomalies.

For example, the software application 124 may query the data stored within the database 122 that has been received over a period of time (e.g., the previous day, week, month, three months, etc.), and divide the data into bins based on attributes of the data, for example, geographic locations, purposes, types, and the like, and analyze the data for anomalies. The software application 124 may generate thresholds (e.g., maximum threshold, minimum threshold, etc.) which identify the normal values for the data. When a bin contains values that exceed the maximum threshold or fall below the minimum threshold, the bin may be determined to contain an anomaly.

Examples of anomalies may include data values that are outside of a maximum and minimum threshold for the data values. For example, card members from a particular country may be incorrectly billed/charged for more than the required surcharge tax amount on applicable foreign transactions due to the number of days included in the calculation. The issue may be due to a number of days being wrongly included in the cycle cut-off period and that not all the payments made by the card members were considered before calculating the tax. The root cause of this situation may be an incorrect application code. The incorrect application code may result in Structured Query Language (SQL) queries that are used to update the cycle cut-off dates that were incorrect and more than the required number of days were getting incorrectly added. To resolve the problem, the SQL queries may be fixed to rectify the error.

As another example, a charge-out process from country A to country B may be inadvertently overcharging customers. In this case, the anomaly may be caused by a manual update to a year-to-date (YTD) rule which does not include prior periods of activity that were already charged and should have been excluded in the YTD accounting rule setup. As a result, the amount already charged from country A to country B, in previous months, is incorrectly charged again. The root cause of this situation may be an incorrect YTD accounting rule that may be incorrectly configured. To resolve this issue, the YTD accounting rule may be updated and fixed.

As another example, on the last day of a reporting period (for example, monthly), an accounts payable system may receive an automated pricing feed from an external storage that can be utilized to record investments at market value. If there are pricing issues that need to be manually changed, an email may be sent to change the appropriate price. A communication error may occur from an employee who provides an incorrect rate of 0.015 instead of 99.9995 resulting in an incorrect calculation or anomaly. The root cause of this problem may be determined to be a manual process triggered due to absence of an automated feed followed by a communication error. The issue may be resolved.

These anomalies can now be detected in real-time (as they are occurring) or in near real-time (after they are occurring) by the system described herein and an alert can be generated to notify one or more nodes of the systems in FIGS. 1A and/or 1B, users of the system(s), administrators, etc. of the issue immediately. In addition, as further described herein, the instant system(s) can take steps to proactively determine the cause of the anomalies, a potential solution for the respective cause, and test/simulate the solution to determine if the solution functions properly.

The thresholds for anomaly detection (e.g., data points that are outliers in the data) can be determined dynamically, for example, based on historical data that may be analyzed using a rolling window (e.g., the previous day, the previous week, the previous month, the previous two months, the previous six months, the previous year, etc.) This enables the anomaly detection process to adapt/evolve over time as the data evolves.

In some embodiments, the software application 124 may display the anomaly data (e.g., a heat map, etc.) on the GUI 134 which can be accessible to a remote computing device. For example, the software application 124 may be a web-based application that can be accessed by a computing system 130 by inputting an IP address of the software application 124 into a browser installed on the computing system 130. As another example, the software application 124 may be hosted on a local server (e.g., on-premises) and can be accessed by the computing system 130 over a local network to which both the computing system 130 and the host platform 120 are members of.

In this example, the computing system 130 may include a display device 132 which displays the GUI 134. In some embodiments, the user may enter commands into the GUI 134 via the computing system 130 (e.g., via an input mechanism such as a keyboard, mouse, touching the display device 132, etc.) The GUI 134 may include control elements such as input fields, buttons, sliders, and the like, which enable a user to input commands via the GUI 134.

In some embodiments, the software application 124 may include or may be communicatively coupled to at least one AI model 126. The software application 124 may call the at least one AI model 126 to determine/predict a cause of the anomaly, determine/predict a solution to the anomaly, test the solution, and the like. The at least one AI model may be used by the software application 124 to modify the GUI 134 including changing colors, shading, etc. of display elements within the heat map.

FIGS. 1C and 1D illustrate processes 140 and 160, respectively, of detecting an anomaly in the data and displaying information about the anomaly according to embodiments of the instant solution. The instant solution includes a modular platform comprising several integrated engines and components, each designed to handle specific tasks related to data anomaly detection and observability. The platform's core components include:

### Bin Aggregation Engine

The bin aggregation engine 142 can be configured to aggregate large volumes of financial data into bins based on business rules. These bins may be defined by various criteria such as product, market, region, currency, or specific numerical ranges. The engine reduces the data volume by creating aggregated records, which are then analyzed for anomalies.

Data related to various transactions can be ingested, in near-real time, by the bin aggregation engine 142. Such transactions include a credit card transaction (at a point-of-sale terminal, at a website, using an app, etc.), a checking or savings account transaction, a certificate of deposit transaction, and the like. The bin aggregation engine 142 can be a lightweight aggregation engine installed on a data processing application 144A, 144B, or 144n or data processing application server 162. The instant solution can be a part of or interfaced with an enriched dataset which can be configured to report any anomalies that may have been created as part of processing by the data processing application(s) 144A, 144B, or 144n and to stop anomalous data from flowing to downstream systems and applications.

The bin aggregation engine 142 can be configured to create aggregated records of these various transactions. These records consist of at least one of counts of transactions, sums of balances/principal/interest, etc. that are grouped on dimensional values such as product, market, region, currency and/or amount ranges such as <0, 0 to 3000, 3000 to 10000, >10000, etc.

The bin aggregation engine 142 reduces large volumes of data into aggregated records (resulting, for example, in a record less than 0.001% of the total volume) by, for example, a counting and summing function and then sends the aggregated records to a distributed event store and stream-processing platform 146 running on a streaming server 164 to process the aggregated records.

A bin aggregation engine 142 that can be running on a data processing Application Server 162, can be configured to pull data representing these transactions from a table, filter the data by the market code for the country, and count the transactions. Millions of rows for a market code of a country can exist, and the bin aggregation engine 142 can be configured to produce a single data record, which can be the bin value for the count of transactions for the market code of that country.

### Bin Collection Engine

The bin collection engine 148 can be configured to process the aggregated data, mapping it into the appropriate bins and storing the bin values in a database. The engine also performs a scoring function to assess the severity of any deviations based on statistical measures such as standard deviation. For each bin, high-level and low-level markers are pre-computed based on historical data and validated. The engine monitors data in real-time and generates alerts when data points deviate from an expected range.

### Anomaly Engine

The anomaly engine 154 can be configured to apply statistical models to the bin data, using sigma levels to identify outliers. Data points falling outside of a certain range, for example 3-Sigma, are flagged as potential anomalies. The engine then uses machine learning models to validate these anomalies, distinguishing between true positives and false positives.

### Autonomous Learning Engine

The autonomous learning engine 168 can be communicatively coupled to the core application server 166 and can be configured to continuously analyze historical data to update the statistical markers and thresholds used in anomaly detection. The engine automatically re-trains these markers based on new data patterns, ensuring that the system adapts to changes over time.

### Governance Engine

The governance engine 156 can be configured to allow for manual review and approval of anomaly markers and thresholds. A user and/or the engine itself assesses the marker's relevance and accuracy, ensuring that only valid markers are used for monitoring. Through a bins rules authoring user interface (UI) and workflow systems 150, decisions can be overridden, thresholds can be adjusted, and false positives can be identified and corrected. The governance process involves a feedback loop where a user and/or the engine itself can report false positives or negatives, further refining the system. The engine ensures that the system remains aligned with business policies and regulatory requirements.

### Anomaly Alerting Engine

The anomaly alerting engine 158 can be configured to generate real-time alerts based on the anomalies detected by the anomaly engine 154. Alerts can be customized based on severity, data source, and recipient preferences. The engine supports various notification methods, including email, SMS, and integration with external systems.

### Analytical Dashboard

The analytical dashboard 152 can be configured to provide an overview of daily transactions and anomalies across various bins and allows a visualization of bin data, trends, and anomalies. The dashboard supports drill-down analysis, enabling users to investigate specific data points identify patterns and understand the root causes of anomalies. The analytical dashboard 152 can be customized to focus on specific data sets or time periods.

The following is an example data flow of the instant solution:

A bin can be defined at a time of onboarding of a new system of record. A bin might consist of a count of transactions where a market code is, for example, a country.

The bin aggregation engine 142 that can be running on the data processing application server 162, can be configured to pull data representing these transactions from a table, filter the data by the market code for the country, and count the transactions. Millions of rows for a market code of a country can exist, and the bin aggregation engine 142 can be configured to produce a single data record, which is the bin value for the count of transactions for the market code of that country.

This data can then be published to the distributed event store and stream-processing platform 146 running on the streaming server 164. The bin collection engine 148 in the core application server 166 can be configured to constantly check for new data in the distributed event store and stream-processing platform 146. Once it finds new data, it sends the data to the core application server 166 and stores the data in a database.

The stored data can then be scored but before scoring can occur, the bin can be trained on a historical data range, and the min/max threshold can be identified. The threshold value for a bin can be preferably set at 3 standard deviations from the mean but any standard deviation can be used. If the data is scored as normal, within the threshold, then no further action is taken. These bins can be marked in a particular color. If the data can be scored as anomalous, outside of the threshold, it can be passed to a machine learning (ML) or Artificial Intelligence (AI) model (residing on the core application server 166 or communicatively coupled to the core application server 166) that can be executed to check if it is a false positive or true positive.

The ML model checks the data for various information including month-end processes, organic growth, organic decline, etc. The ML or AI model can be trained using a neural network training capability with at least one of historical logs and model feedback data to generate market data. The ML or AI model can be executed to predict a possibility of anomalous data existing.

If the data is a false positive, it can be noted as such in the database, and no further action is taken. If the data is indicated to be a true positive (these bins can be marked in a particular color), it can be passed to another ML model or a different application which has been trained on previous data where data have been labelled as true anomalies.

This information can be displayed on the bin rules authoring UI and workflow system 150 and can be viewed and acted upon by a user or by the core application server 166. The anomaly alert engine 158 can be configured to send an alert related to the data anomaly and the possible root cause. The issue can then be corrected and the correct data can then be populated in the table.

FIG. 2A illustrates a process 200A of generating a heat map of an anomaly within bins of data according to an embodiment of the instant solution. Referring to FIG. 2A, the software application (shown in FIG. 1B) may generate a graphical user interface (GUI) which includes an anomaly heat map 210, bin values 220, and the like. For example, the software application may divide the data into bins of data based on configurations which are defined within the software application. In this example, the software application bins the data using two dimensions including a first dimension that represents a source geographic location (e.g., country, etc.) and a second dimension that represents periods of time (e.g., a day, a week, etc.) The software application may generate a two-dimensional (2D) array of graphical elements as shown in anomaly heat map 210 which are arranged based on the values of the first and second dimensions. Here, each graphical element represents a different bin. The bins of data may include pieces of data (e.g., payment transactions, etc.) that occur in a particular country during a particular period of time.

The software application may analyze the data within the bins to determine whether any of the bins contain anomalies. Anomalies may include data being below a minimum threshold, data being above a maximum threshold, and the like. When an anomaly is detected within a bin, the software application may adjust a visual appearance (e.g., color, shading, boundary, size, shape, etc.) of a graphical element in the anomaly heat map 210 that corresponds to the bin of data. For example, the software application may adjust the visual appearance of the graphical element based on the legend 214 shown within the anomaly heat map 210.

Furthermore, the software application may also present the values of the data within the bin values 220 section of the GUI. For example, the bin values 220 include a plurality of points 226 which correspond to bin values. The bin values may be compared to a minimum threshold 224 and a maximum threshold 225 to determine whether the bin values are an anomaly. For example, a bin value below the minimum threshold 224 may be determined to be an anomaly. Likewise, a bin value above the maximum threshold 225 may be determined as an anomaly.

In the example of FIG. 2A, a bin value 221 that is below the minimum threshold 224 corresponds to a graphical element 211 within the heat map. In this case, the software application changes a visual appearance of the graphical element 211 based on the legend 214 to indicate that the bin value corresponding to the graphical element 211 is an anomaly, and in particular, is an anomaly because it is below the minimum threshold 224. Meanwhile, a bin value 222 and a bin value 223 are both above the maximum threshold 225 and correspond to a graphical element 212 and a graphical element 213, respectively, in the anomaly heat map 210. In this example, the software application changes a visual appearance of the graphical elements 212 and 213 based on the legend 214 to indicate that the bin value corresponding to the graphical elements 212 and 213 are anomalies, and in particular, are above the maximum threshold 225.

The software application may also display the other graphical elements within the heat map corresponding to the other bin values that are within the minimum threshold 224 and the maximum threshold 225, to indicate the other bin values are normal/as expected.

FIG. 2B illustrates a process 200B of configuring the anomaly detection according to an embodiment of the instant solution. According to various embodiments, the anomaly detection process may be configured through settings within the software application. Referring to FIG. 2B, the settings for configuring the binning and anomaly detection process may be set via a pop-up menu 230. For example, a user may press a button 227 within the graphical user interface which causes the software application to initiate a display of the pop-up menu 230. In this example, the pop-up menu includes controls (e.g., drop down fields, etc.) for configuring the binning and anomaly detection process.

For example, a drop-down field 231 may be used to configure which data to analyze for anomalies. The data may include past/historical data, real-time data, or near real-time data, data from a period of time, and the like. In addition, a drop-down field 232 may be used to configure a source of the data, for example, a software application (e.g., mobile payment application, database application, API, content delivery application, etc.) which can be the source of the data. Furthermore, a drop-down field 233 may be used to configure a data type to be analyzed (e.g., transactions being sent to a particular jurisdiction, etc.) In addition, a drop-down field 234 may be used to configure a source table for retrieving the data, and the like.

The fields shown in FIG. 2B and the use of drop-downs are presented by example only. It should be appreciated that different data attributes, sources, and the like, may be used to configure the binning and anomaly detection process, and different types of control mechanisms (e.g., buttons, checkboxes, sliders, etc.) may be used to determine how to bin the data and how to identify the anomalies.

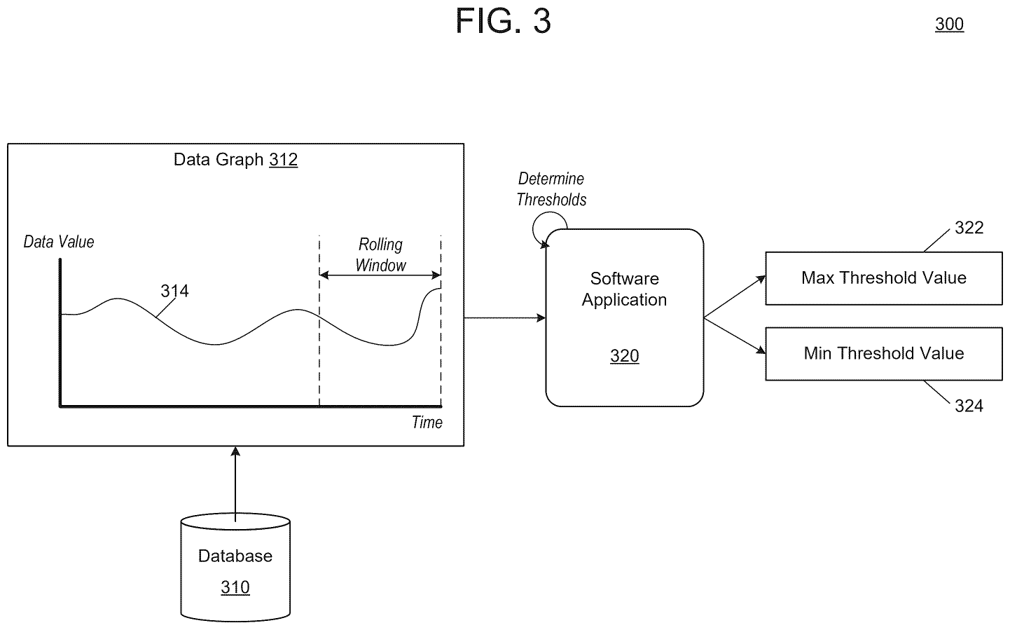

FIG. 3 illustrates a process 300 of dynamically generating thresholds for anomaly detection according to an embodiment of the instant solution. In the example of FIG. 2A, the software uses the minimum threshold 224 and the maximum threshold 225 to identify anomalies. These thresholds may be determined dynamically, for example, based on the example that is shown and described with respect to FIG. 3. Referring to FIG. 3, a software application 320 may dynamically determine the thresholds used for anomaly detection using a fixed window or a rolling window of historical data. The software application 320 may correspond to the software application 124 shown in the example of FIG. 1B. If the data corresponds to payment transactions, the software application 320 may use historical payment transactions from a previous window of time (e.g., two months ago until the present time, etc.) to determine the thresholds values.

For example, the software application 320 may ingest historical data (represented by data graph 312) from a database 310. The software application 320 may use one or more predefined algorithms, functions, to determine the threshold values. For example, the software application 320 may identify a median, mean, standard deviation, and the like, of the data value from the historical data and use a predefined algorithm, function, or the like, to determine the thresholds. As an example, the software may set the maximum threshold value to be three standard deviations away from the mean value of the data, but this is just one example. A similar function can be used to set the minimum threshold value. Although not shown in FIG. 3, it should be appreciated that different mechanisms may be used to determine the thresholds. As another example, execution on an AI model on the historical data may be used to determine the thresholds.

In this example, the software application uses a value 314 of the data over time, and in particular, a rolling window 316 of the value of the data. The rolling window 316 may include a most recent period of time prior to the current point in time, for example, the last week, the last month, the last two months, the last year, and the like. In this example, the rolling window 316 corresponds to the previous one month. Meanwhile, the data value corresponds to a count of transactions that are executed in a particular country (e.g., New Zealand, etc.) The data graph 312 shows the count of the transactions that are executed in the particular country over time. The rolling window only includes a subset of the time. The software application 320 may execute the predefined algorithms/functions on the data value within/during the rolling window 316 to determine a maximum threshold value 322 and a minimum threshold value 324.

In some embodiments, the system described herein may also determine a cause of the anomaly and take action to prevent the anomaly from continuing. For example, the system may determine a potential solution to the anomaly using artificial intelligence. The system may also test the potential solution through a simulation.

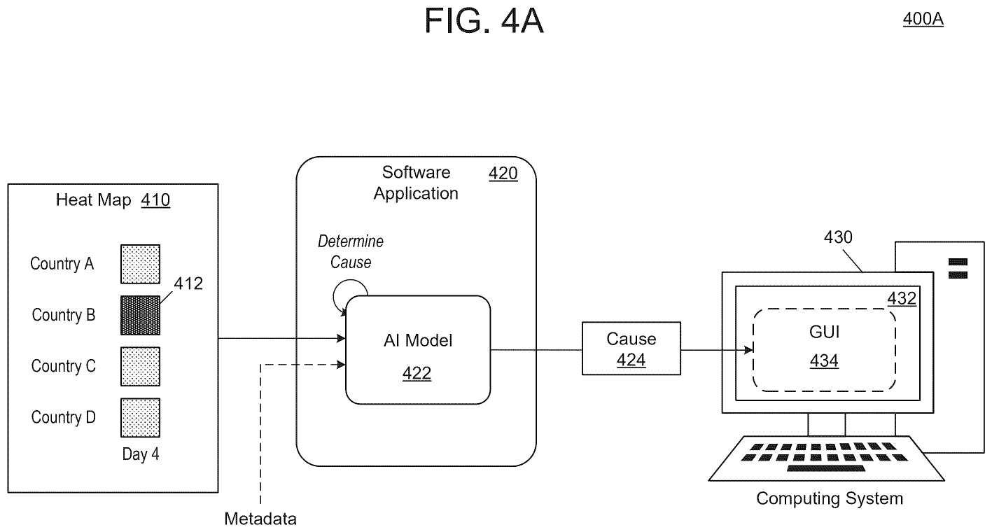

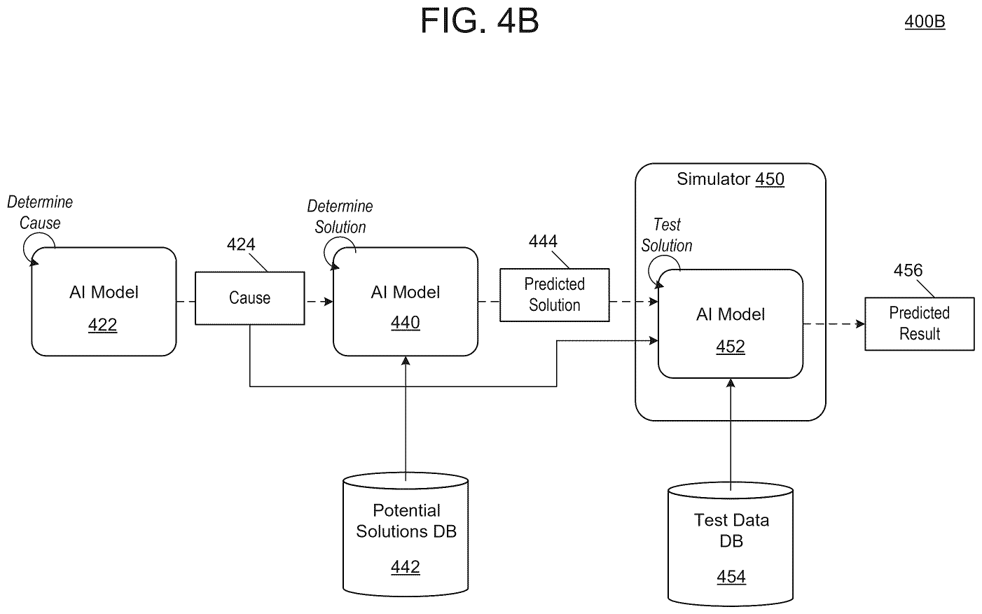

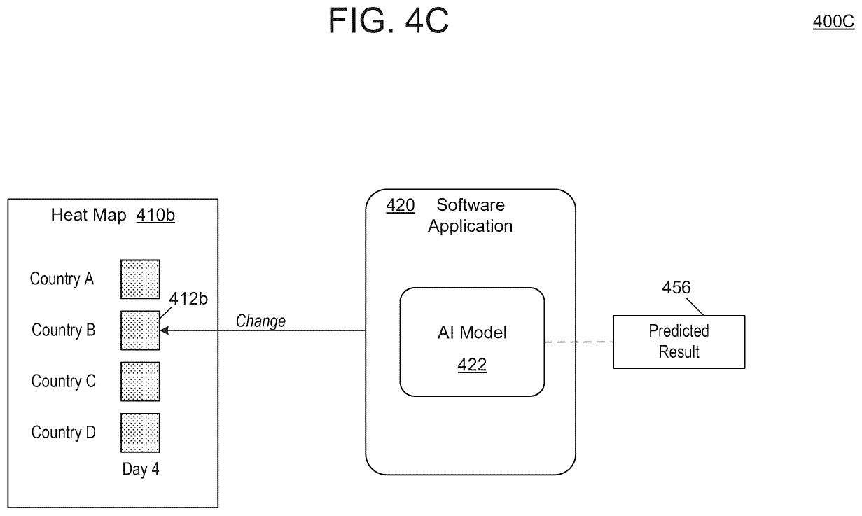

FIG. 4A illustrates a process 400A of determining a cause 424 of an anomaly within the data according to an embodiment of the instant solution. Referring to FIG. 4A, a software application 420 may use one or more artificial intelligence (AI) models to perform a sequence of steps to correct the anomaly. For example, the software application 420 may retrieve data of the anomaly and metadata of the data from a database. The data can be represented by a heat map 410 that includes a row of data from a larger heat map. In this example, a graphical element 412 is colored to indicate an anomaly, while the other graphical elements in the heat map are colored with a different color indicating that there is no anomaly. In addition to the data, the software application 420 may also ingest metadata of the data, which may correspond to attributes that identify the category of a transaction, transaction context such as location, time of day, geographic location, and the like.

The software application 420 may ingest the data and the metadata and execute an AI model 422 on the ingested data to predict the cause 424 of the anomaly. The AI model 422 may be trained to identify anomalies within the data based on historical anomalies, historical context, metadata, etc. of the anomalies, and the like. The software application 420 may display the cause 424 on a GUI 434 of the software application 420. The GUI 434 may be accessible to a computing system 430 and viewable on a display device 432 of the computing system 430.

FIG. 4B illustrates a process 400B of determining and testing a solution for the anomaly according to an embodiment of the instant solution. Referring to FIG. 4B, the software application 420 may chain together a plurality of AI models to determine a solution to the cause of the anomaly, and to test the solution. For example, the cause 424 may be output from the AI model 422 and input to an AI model 440. The AI model 440 may also ingest potential solutions from a database 442, and execute on an input that includes the cause 424 and the potential solutions, and the like, to predict a solution 444 to correct the anomaly.

The predicted solution 444 may be output to a simulator 450 (e.g., software application, service, etc.) through an API call to the simulator 450. The API call may identify the anomaly, the cause, the solution, and the like, and may be sent to the simulator 450 by the software application 420. The simulator 450 may execute an AI model 452 on the content of the API call and may test the predicted solution being implemented with respect to the data and simulate future data based on the simulation. In some embodiments, the simulator 450 may obtain test data from a database 454 and input the test data to the AI model 452 to predict the test results 456. The test results 456 may indicate that the solution is successful. If the solution is successful, the software application 420 may modify the heat map 410.

FIG. 4C illustrates a process 400C of modifying the heat map when an anomaly is solved according to an embodiment of the instant solution. Referring to FIG. 4C, the software application 420 may modify the heat map 410 by changing the color of the graphical element 412 to a different color to generate a modified graphical element 412b and likewise a modified heat map 410b as shown in FIG. 4C. The modification may be performed in an automated manner thereby communicating to the viewer that the anomaly has been corrected.

Detailed descriptions of training a machine learning model and executing a machine learning model are further described and depicted herein.

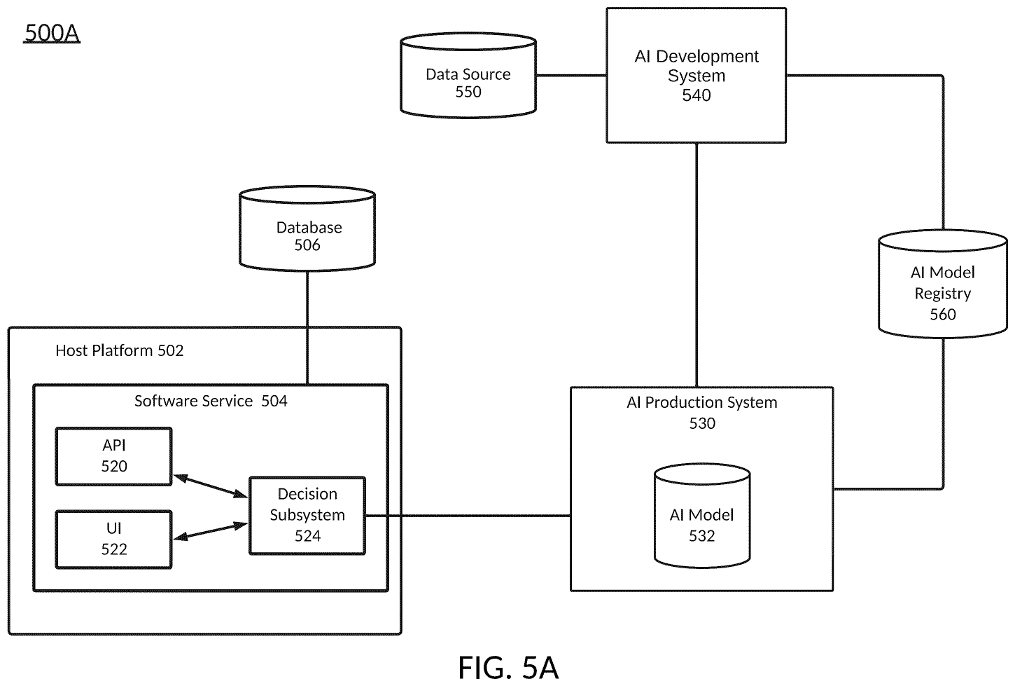

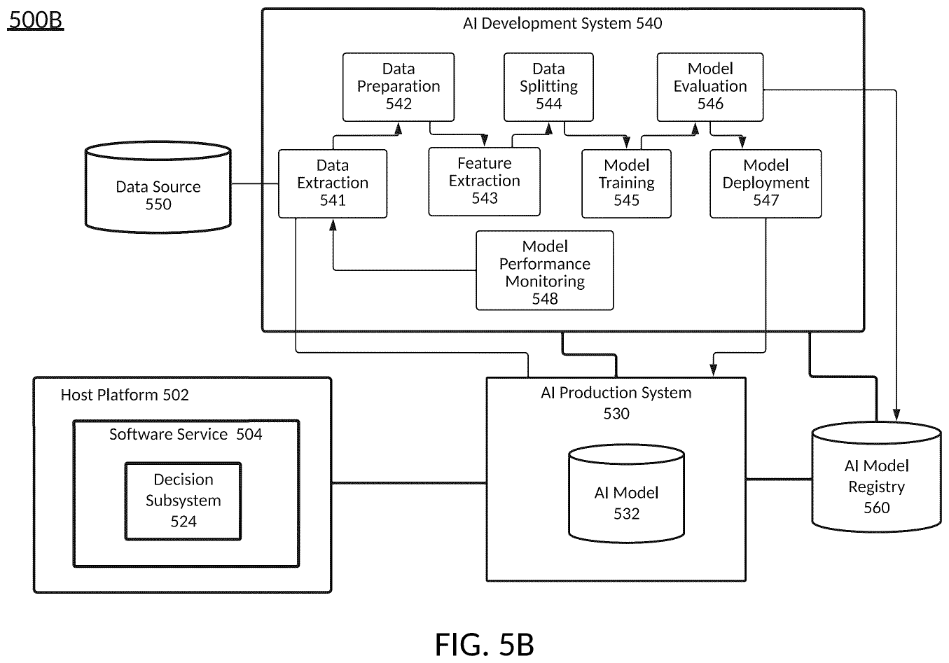

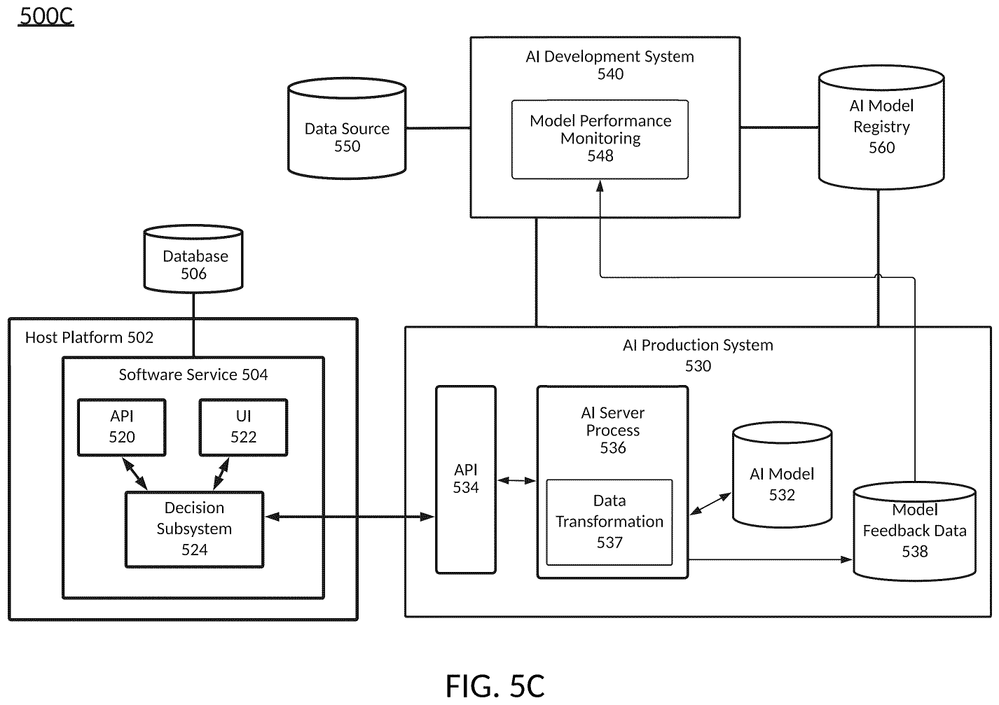

FIG. 5A illustrates an example of an instant artificial intelligence (AI) network 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification can be known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind can be the next progression of AI that may be able to perceive, connect, and react by generating appropriate reactions in response to an entity with which the AI model can be interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model may be able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly cab be used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model can be fine-tuned with a domain-specific unlabeled corpus to create a domain-specific foundation model. Then, using a much smaller amount of labeled data, potentially just a thousand labeled examples, a foundation model can be trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences 100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 can be hosted on a server. In some examples and features of the instant solution, the AI production system 530 can be cloud-hosted. In some examples and features of the instant solution, the AI production system 530 can be deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 can be cloud hosted. In some examples and features of the instant solution, the AI development system 540 can be deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 can be cloud-hosted. In some examples and features of the instant solution, the AI model registry 560 resides in the AI production system 530. In some examples and features of the instant solution, the AI model registry 560 can be a distributed database.

FIG. 5B illustrates a process 500B for developing one or more AI models that support instant AI-assisted decision points. An AI development system 540 executes steps to develop an AI model 532 that begins with data extraction 541, in which data can be loaded and ingested from one or more data sources 550. In some examples and features of the instant solution, historical model feedback data can be extracted from one or more AI production systems 530.

Once the data has been extracted during data extraction 541, the data undergoes data preparation 542 for model training. In some examples and features of the instant solution, this step may involve statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

At step 543, features of the data may be identified and extracted. In some examples and features of the instant solution, a feature of the data can be internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 can be split 544 into a training and validation data set. The training data set can be used to train the AI model 532, and the validation data set can be used to evaluate the performance of the AI model 532 on unseen data.

The AI model 532 can be trained and tuned 545 using the training data set from the data splitting step 544. In this step, the training data set can be provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance can be acceptable based on various goals and/or results.

The AI model 532 can be evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 can be used. In some examples and features of the instant solution, one or more unseen validation datasets are used. In some examples and features of the instant solution, the staging environment can be part of the AI development system 540, and the staging environment can be managed separately from the AI development system 540. Once the AI model 532 has been validated, it can be stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 can be monitored 548 by the AI development system 540. In some examples and features of the instant solution, AI model 532 feedback data can be provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an instant AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an instant AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) can be included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which can be a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data can be streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

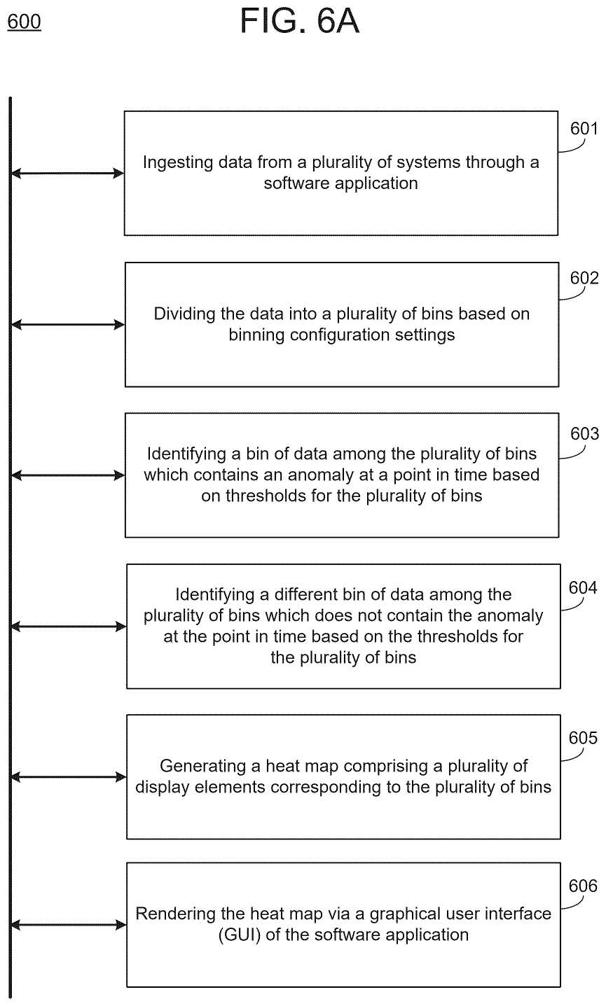

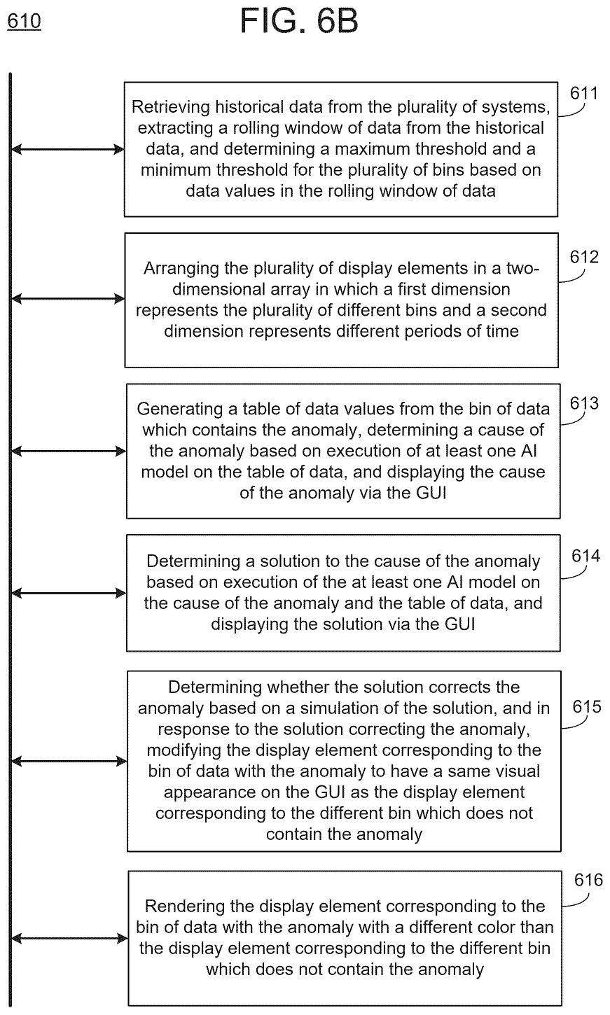

FIG. 6A illustrates a flow diagram of a method 600, according to example embodiments. Referring to FIG. 6A, in 601, the method may include ingesting data from a plurality of systems through a software application. In 602, the method may include dividing the data into a plurality of bins based on binning configuration settings that are defined within the software application. In 603, the method may include identifying a bin of data among the plurality of bins which contains an anomaly at a point in time based on thresholds for the plurality of bins. In 604, the method may include identifying a different bin of data among the plurality of bins which does not contain the anomaly at the point in time based on the thresholds for the plurality of bins. In 605, the method may include generating a heat map comprising a plurality of display elements corresponding to the plurality of bins including a display element corresponding to the bin of data with the anomaly with a different visual appearance than a display element corresponding to the different bin which does not contain the anomaly. In 606, the method may include rendering the heat map via a graphical user interface (GUI) of the software application.

FIG. 6B illustrates a flow diagram of a method 610, according to example embodiments. Referring to FIG. 6B, in 611, the method may include retrieving historical data from the plurality of systems, extracting a rolling window of data from the historical data, and determining a maximum threshold and a minimum threshold for the plurality of bins based on data values included within the rolling window of data. In 612, the method may include arranging the plurality of display elements in a two-dimensional array in which a first dimension of the two-dimensional array represents the plurality of different bins and a second dimension of the two-dimensional array represents different periods of time.

In 613, the method may include generating a table of data values from the bin of data which contains the anomaly at the point in time, determining a cause of the anomaly based on execution of at least one artificial intelligence (AI) model on the table of data, and displaying the cause of the anomaly via the GUI. In 614, the method may include determining a solution to the cause of the anomaly based on execution of the at least one AI model on the cause of the anomaly and the table of data, and displaying the solution via the GUI.

In 615, the method may include determining whether the solution corrects the anomaly based on a simulation of the solution, and in response to a determination that the solution corrects the anomaly, modifying the display element corresponding to the bin of data with the anomaly to have a same visual appearance on the GUI as the display element corresponding to the different bin which does not contain the anomaly. In 616, the method may include rendering the display element corresponding to the bin of data with the anomaly with a different color than the display element corresponding to the different bin which does not contain the anomaly.

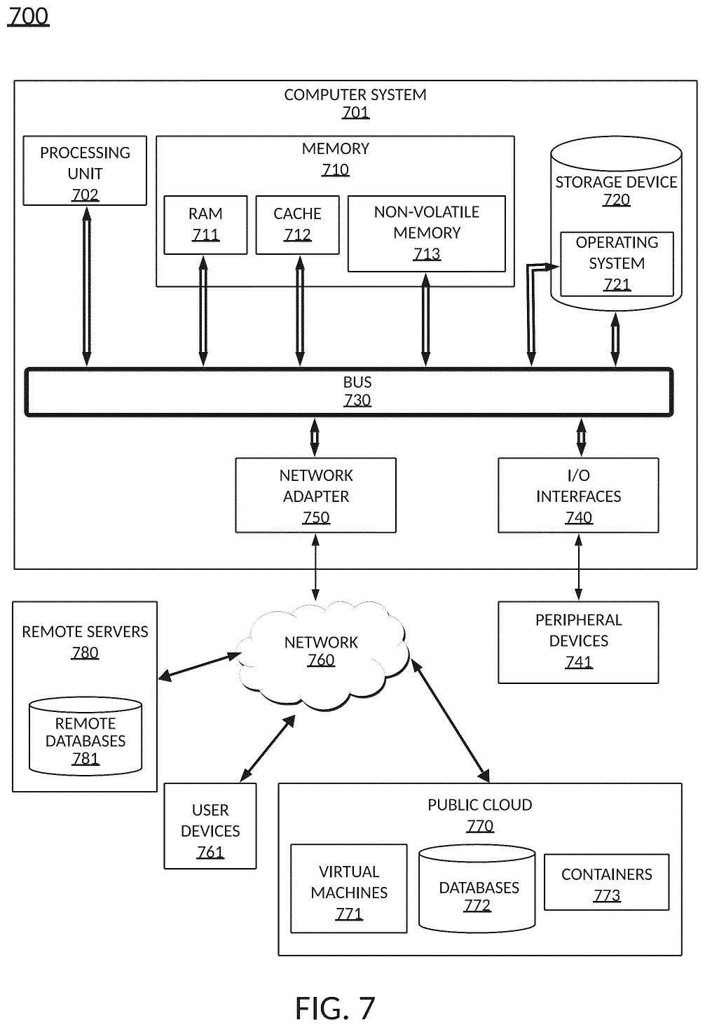

The examples and features of the instant solution may be implemented in at least one of the elements described or depicted herein, including for example, the elements described or depicted in FIG. 7. These examples and features may further be implemented in hardware, in a computer program executed by a processor, in firmware, or in a combination of the above. A computer program, or a computer program product may be embodied on a computer-readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 7 illustrates an example computer system architecture, which may represent or be integrated in any of the above-described components, etc.

FIG. 7 illustrates a computing environment according to the instant solution's example features, structures, or characteristics. FIG. 7 is not intended to suggest any limitation as to the scope of use or functionality of features, structures, or characteristics of the instant solution of the application described herein. Regardless, the computing environment 700 can be implemented to perform any of the functionalities described herein. In computing environment 700, there can be a computer system 701, operational within numerous other general-purpose or special-purpose computing system environments or configurations.

Computer system 701 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 760 or querying a database. Depending upon the technology, the performance of a computer-implemented method may be distributed among multiple computers and among multiple locations. However, in this presentation of the computing environment 700, a detailed discussion can be focused on a single computer, specifically computer system 701, to keep the presentation as simple as possible.

Computer system 701 may be located in a cloud, even though it is not shown in a cloud in FIG. 7. On the other hand, computer system 701 may not be in a cloud except to any extent as may be affirmatively indicated. Computer system 701 may be described in the general context of computer system-executable instructions, such as program modules, executed by a computer system 701. Generally, program modules may include routines, programs, objects, components, logic, data structures, and so on that perform tasks or implement certain abstract data types. As shown in FIG. 7, computer system 701 in computing environment 700 is shown in the form of a general-purpose computing device. The components of computer system 701 may include but are not limited to, at least one processor or processing unit 702, a system memory 710, and a bus 730 that couples various system components, including system memory 710 to processing unit 702.

Processing unit 702 includes at least one computer processor of any type now known or to be developed. The processing unit 702 may contain circuitry distributed over multiple integrated circuit chips. The processing unit 702 may also implement multiple processor threads and multiple processor cores. Cache 712 is a memory that may be in the processor chip package(s) or located “off-chip,” as depicted in FIG. 7. Cache 712 can be used for data or code accessed by the threads or cores running on the processing unit 702. In some computing environments, processing unit 702 may be designed to work with qubits and perform quantum computing.

The Auxiliary Processing Units (APU) 703 may contain at least one Graphics Processing Unit (GPU) 704, Neural Processing Unit (NPU) 705, Tensor Processing Unit (TPU) 706, AI Processor (AIP) 707, or other Application Specific Integrated Circuit (ASIC) 708. The at least one APU 703 may contain circuitry distributed over multiple integrated circuit chips. Each APU 703 may implement multiple processor threads and multiple processor cores. Each APU 703 may include at least one of onboard memory, onboard memory cache, and onboard instruction cache. Each APU may be communicatively coupled to the system bus 730 and configure to communicate with other system components, including a processing unit 702, system cache 712, RAM 711, non-volatile RAM 713, operating system 721, Network adapter 750, and Input/Output interfaces 740. In some computing environments, at least one of the at least one APU 703 may be designed to work with qubits and perform quantum computing.

Memory 710 is any volatile memory now known or to be developed in the future. Examples include dynamic random-access memory (RAM) 711 or static type RAM 711. Typically, the volatile memory is characterized by random access, but this may not be the characterization unless affirmatively indicated. In computer system 701, memory 710 is in a single package. It is internal to computer system 701, but alternatively or additionally, the volatile memory may be distributed over multiple packages and/or located externally with respect to computer system 701. By way of example, memory 710 can be provided for reading from and writing to a non-removable, non-volatile magnetic media (shown as storage device 720, and typically called a “hard drive”). Memory 710 may include at least one program product having a set (e.g., at least one) of program modules configured to carry out the functions of various features, structures, or characteristics of the instant solution of the application. A typical computer system 701 may include cache 712, a specialized volatile memory generally faster than RAM 711 and generally located closer to the processing unit 702. Cache 712 stores frequently accessed data and instructions accessed by the processing unit 702 to speed up processing time. The computer system 701 may also include non-volatile memory 713 in the form of ROM, PROM, EEPROM, and flash memory. Non-volatile memory 713 often contains programming instructions for starting the computer, including the basic input/output system (BIOS) and information to start the operating system 721.

Computer system 701 may include a removable/non-removable, volatile/non-volatile computer storage device 720. For example, storage device 720 can be a non-removable, non-volatile magnetic media (not shown and typically called a “hard drive”). At least one data interface can connect it to the bus 730. In features, structures, or characteristics of the instant solution where computer system 701 has a large amount of storage (for example, where computer system 701 locally stores and manages a large database), then this storage may be provided by peripheral storage devices 720 designed for storing very large amounts of data, such as a storage area network (SAN) that is shared by multiple, geographically distributed computers.

The operating system 721 is software that manages computer system 701 hardware resources and provides common services for computer programs. Operating system 721 may take several forms, such as various known proprietary operating systems or open-source Portable Operating System Interface type operating systems that employ a kernel.

The bus 730 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 730 is the signal conduction path that allows the various components of computer system 701 to communicate.

Computer system 701 may communicate with at least one peripheral device, 741, via an input/output (I/O) interface, 740. Such devices may include a keyboard, a pointing device, a display, etc.; at least one device that enables a user to interact with computer system 701; and/or any devices (e.g., network card, modem, etc.) that enable computer system 701 to communicate with at least one other computing devices. Such communication can occur via I/O interface 740. As depicted, I/O interface 740 communicates with the other components of computer system 701 via bus 730.

Network adapter 750 enables the computer system 701 to connect and communicate with at least one network 760, such as a local area network (LAN), a wide area network (WAN), and/or a public network (e.g., the Internet). It bridges the computer's internal bus 730 and the external network, exchanging data efficiently and reliably. The network adapter 750 may include hardware, such as modems or Wi-Fi signal transceivers, and software for packetizing and/or de-packetizing data for communication network transmission. Network adapter 750 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 760 is any computer network that can receive and/or transmit data. Network 760 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 760 may be replaced and/or supplemented by LANs designed to communicate data between devices in a local area, such as a Wi-Fi network. The network 760 typically includes computer hardware such as copper transmission cables, optical transmission fibers, wireless transmission, routers, firewalls, switches, gateway computers, edge servers, and network infrastructure known now or to be developed in the future. Computer system 701 connects to network 760 via network adapter 750 and bus 730.

User devices 761 are any computer systems used and controlled by an end user in connection with computer system 701. For example, in a hypothetical case where computer system 701 is designed to provide a recommendation to an end user, this recommendation may typically be communicated from network adapter 750 of computer system 701 through network 760 to a user device 761, allowing user device 761 to display, or otherwise present, the recommendation to an end user. User devices can be a wide array, including personal computers, laptops, tablets, hand-held, mobile phones, etc.

A public cloud 770 is an on-demand availability of computer system resources, including data storage and computing power, without direct active management by the user. Public clouds 770 are often distributed, with data centers in multiple locations for availability and performance. Computing resources on public clouds 770 are shared across multiple tenants through virtual computing environments comprising virtual machines 771, databases 772, containers 773, and other resources. A container 773 is an isolated, lightweight software for running a software application on the host operating system 721. Containers 773 are built on top of the host operating system's kernel and contain software applications and some lightweight operating system APIs and services. In contrast, virtual machine 771 is a software layer with an operating system 721 and kernel. Virtual machines 771 are built on top of a hypervisor emulation layer designed to abstract a host computer's hardware from the operating software environment. Public clouds 770 generally offers databases 772, abstracting high-level database management activities. At least one element described or depicted in FIG. 7 can perform at least one of the actions, functionalities, or features described or depicted herein.

Remote servers 780 are any computers that serve at least some data and/or functionality over a network 760, for example, WAN, a virtual private network (VPN), a private cloud, or via the Internet to computer system 701. These networks 760 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 780 can also host remote databases 781, with the database located on one remote server 780 or distributed across multiple remote servers 780. Remote databases 781 are accessible from database client applications installed locally on the remote server 780, other remote servers 780, user devices 761, or computer system 701 across a network 760. An AI/ML model described or depicted here may reside fully or partially on any of the elements described or depicted in FIG. 7.

Although an exemplary example of the instant solution of at least one of an apparatus, method, and computer-readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

The above embodiments may be implemented in hardware, in a computer program executed by a processor, in firmware, or in a combination of the above. A computer program or computer program product may be embodied on a computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. An apparatus comprising:
a memory; and
at least one processor that is communicatively coupled to the memory, the at least one processor configured to:
ingest data from a plurality of systems through a software application;
divide the data into a plurality of bins based on binning configuration settings that are defined within the software application;
identify a bin of data among the plurality of bins which contains an anomaly at a point in time based on thresholds for the plurality of bins;
identify a different bin of data among the plurality of bins which does not contain the anomaly at the point in time based on the thresholds for the plurality of bins;
generate a heat map comprising a plurality of display elements corresponding to the plurality of bins including a display element corresponding to the bin of data with the anomaly with a different visual appearance than a display element corresponding to the different bin which does not contain the anomaly; and
render the heat map via a graphical user interface (GUI) of the software application.

2. The apparatus of claim 1, wherein the at least one processor is further configured to retrieve historical data from the plurality of systems, extract a rolling window of data from the historical data, and determine a maximum threshold and a minimum threshold for the plurality of bins based on data values included within the rolling window of data.

3. The apparatus of claim 1, wherein the at least one processor is configured to arrange the plurality of display elements in a two-dimensional array in which a first dimension of the two-dimensional array represents the plurality of bins and a second dimension of the two-dimensional array represents different periods of time.

4. The apparatus of claim 1, wherein the at least one processor is further configured to generate a table of data values from the bin of data which contains the anomaly at the point in time, determine a cause of the anomaly based on execution of at least one artificial intelligence (AI) model on the table of data, and display the cause of the anomaly via the GUI.

5. The apparatus of claim 4, wherein the at least one processor is further configured to determine a solution to the cause of the anomaly based on execution of the at least one AI model on the cause of the anomaly and the table of data, and display the solution via the GUI.

6. The apparatus of claim 5, wherein the at least one processor is further configured to determine whether the solution corrects the anomaly based on a simulation of the solution.

7. The apparatus of claim 6, wherein the at least one processor is further configured to, in response to a determination that the solution corrects the anomaly, modify the display element corresponding to the bin of data with the anomaly to have a same visual appearance on the GUI as the display element corresponding to the different bin which does not contain the anomaly.

8. A method comprising:
ingesting data from a plurality of systems through a software application;
dividing the data into a plurality of bins based on binning configuration settings that are defined within the software application;
identifying a bin of data among the plurality of bins which contains an anomaly at a point in time based on thresholds for the plurality of bins;
identifying a different bin of data among the plurality of bins which does not contain the anomaly at the point in time based on the thresholds for the plurality of bins;
generating a heat map comprising a plurality of display elements corresponding to the plurality of bins including a display element corresponding to the bin of data with the anomaly with a different visual appearance than a display element corresponding to the different bin which does not contain the anomaly; and
rendering the heat map via a graphical user interface (GUI) of the software application.

9. The method of claim 8, further comprising retrieving historical data from the plurality of systems, extracting a rolling window of data from the historical data, and determining a maximum threshold and a minimum threshold for the plurality of bins based on data values included within the rolling window of data.

10. The method of claim 8, wherein the generating the heat map comprises arranging the plurality of display elements in a two-dimensional array in which a first dimension of the two-dimensional array represents the plurality of bins and a second dimension of the two-dimensional array represents different periods of time.

11. The method of claim 8, further comprising generating a table of data values from the bin of data which contains the anomaly at the point in time, determining a cause of the anomaly based on execution of at least one artificial intelligence (AI) model on the table of data, and displaying the cause of the anomaly via the GUI.

12. The method of claim 11, further comprising determining a solution to the cause of the anomaly based on execution of the at least one AI model on the cause of the anomaly and the table of data, and displaying the solution via the GUI.

13. The method of claim 12, further comprising determining whether the solution corrects the anomaly based on a simulation of the solution.

14. The method of claim 13, further comprising, in response to a determination that the solution corrects the anomaly, modifying the display element corresponding to the bin of data with the anomaly to have a same visual appearance on the GUI as the display element corresponding to the different bin which does not contain the anomaly.

15. A computer program product comprising:
one or more computer-readable storage media; and
program instructions stored on the one or more computer-readable storage media to
perform operations comprising:
ingesting data from a plurality of systems through a software application;
dividing the data into a plurality of bins based on binning configuration settings that are defined within the software application;
identifying a bin of data among the plurality of bins which contains an anomaly at a point in time based on thresholds for the plurality of bins;
identifying a different bin of data among the plurality of bins which does not contain the anomaly at the point in time based on the thresholds for the plurality of bins;
generating a heat map comprising a plurality of display elements corresponding to the plurality of bins including a display element corresponding to the bin of data with the anomaly with a different visual appearance than a display element corresponding to the different bin which does not contain the anomaly; and
rendering the heat map via a graphical user interface (GUI) of the software application.

16. The computer program product of claim 15, wherein the operations further comprise:
retrieving historical data from the plurality of systems, extracting a rolling window of data from the historical data, and determining a maximum threshold and a minimum threshold for the plurality of bins based on data values included within the rolling window of data.

17. The computer program product of claim 15, wherein the generating the heat map comprises:
arranging the plurality of display elements in a two-dimensional array in which a first dimension of the two-dimensional array represents the plurality of bins and a second dimension of the two-dimensional array represents different periods of time.

18. The computer program product of claim 15, wherein the operations further comprise:
generating a table of data values from the bin of data which contains the anomaly at the point in time, determining a cause of the anomaly based on execution of at least one artificial intelligence (AI) model on the table of data, and displaying the cause of the anomaly via the GUI.

19. The computer program product of claim 15, wherein the operations further comprise:
determining a solution to the cause of the anomaly based on execution of the at least one AI model on the cause of the anomaly and the table of data, and displaying the solution via the GUI.

20. The computer program product of claim 15, wherein the operations further comprise:
determining whether the solution corrects the anomaly based on a simulation of the solution, and in response to a determination that the solution corrects the anomaly, modifying the display element corresponding to the bin of data with the anomaly to have a same visual appearance on the GUI as the display element corresponding to the different bin which does not contain the anomaly.
